(19) United States
(12) Patent Application Publication
(10) Pub. No.: US 2013/0103985 A1
(43) Pub. Date: Apr. 25, 2013

(54) METHOD FOR SIMULTANEOUSLY PERFORMING DIAGNOSING AND IMAGE DOWNLOADING OF A CUSTOM-CONFIGURED COMPUTER AND COMPUTER SYSTEM THEREOF

(71) Applicants: Sheng-Pao Huang, Taipei City (TW); Xiaobin Ma, Taipei City (TW)

(72) Inventors: Sheng-Pao Huang, Taipei City (TW); Xiaobin Ma, Taipei City (TW)

(21) Appl. No.: 13/348,644

(22) Filed: Jan. 12, 2012

(30) Foreign Application Priority Data
Oct. 19, 2011 (CN) 201110320375.2

(51) Int. Cl. G06F 11/28

(52) U.S. Cl. 714/32; 714/E11.178

(57) ABSTRACT

A method for simultaneously performing diagnosing and image downloading of a custom-configured computer is disclosed. The method includes receiving a shipping image, extracting the shipping image into a hard disk drive, partitioning a portion in a unused storage space of the hard disk drive, installing a test operating system in the portion of the hard disk drive, deleting all data corresponding to the shipping image of the hard disk drive, writing storage data of the hard disk drive into a shipping hard disk drive of at least one custom-configured computer, writing data corresponding to the shipping image in a network server into the shipping hard disk drive during the test operating system performs diagnosing of the custom-configured computer, and writing a master boot record corresponding to the shipping image into the shipping hard disk drive.

### BACKGROUND OF THE INVENTION

1. Field of the Invention

The present invention relates to a method for performing diagnosing and image downloading and a computer system thereof, and more specifically, to a method for simultaneously performing diagnosing and image downloading of a custom-configured computer and a computer system thereof.

2. Description of the Prior Art

Generally speaking, in addition to hardware assembly, a computer manufacturing process includes two major steps: run-in and image download. The run-in step involves installing a test operating system into a shipping hard disk drive of a custom-configured computer for diagnosing the overall performance of the custom-configured computer. The image download step is to download software (e.g. OS (Operating System), office software) that a customer wants to install into a shipping hard disk drive of a custom-configured computer. After the aforesaid steps are completed, the pre-production of the custom-configured computer is finished accordingly.

However, since the run-in step and the image downloading step need to be performed sequentially after hardware assembly of the custom-configured computer is completed and then the custom-configured computer is moved from the production line to corresponding zones. In other words, after the custom-configured computer is moved to the run-in zone (e.g. a burn-in rack) and the run-in step is then performed on the custom-configured computer (more than two hours is needed), the custom-configured computer can just be moved to the download zone for performing the image downloading step (time needed for performing the image downloading step depends on the size of the shipping image). Thus, the said design may cause a time-consuming and strenuous process, so as to reduce the production efficiency of the custom-configured computer. Although an integrated method for directly performing the run-in and image downloading steps on the production line has been developed in the prior art, the run-in and image downloading steps still need to be performed separately, so as to make time needed for the pre-production of the custom-configured computer too long. Furthermore, the unapproved image and the download problem occurred during the image downloading step may also delay the pre-production of the custom-configured computer.

### SUMMARY OF THE INVENTION

The present invention provides a method for simultaneously performing diagnosing and image downloading of a custom-configured computer. The method includes receiving a shipping image, extracting the shipping image into a hard disk drive, partitioning a portion in a unused storage space of the hard disk drive, installing a test operating system into the portion of the hard disk drive, deleting all data corresponding to the shipping image of the hard disk drive, writing storage data of the hard disk drive into a shipping hard disk drive of at least one custom-configured computer, writing data corresponding to the shipping image in a network server into the shipping hard disk drive during the test operating system performs diagnosing of the custom-configured computer, and writing a master boot record corresponding to the shipping image into the shipping hard disk drive.

The present invention further provides a computer system including a hard disk drive, a network server, and a custom-configured computer. The hard disk drive has a first portion for storing data corresponding to a shipping image and a second portion for storing a test operating system. The network server is coupled to the hard disk drive for storing the data corresponding to the shipping image and storage data of the hard disk drive after deleting all data corresponding to the shipping image of the hard disk drive. The custom-configured computer is coupled to the network server. The custom-configure computer includes a shipping hard disk drive. The shipping hard disk drive is for receiving the storage data of the hard disk drive after deleting the data corresponding to the shipping image of the hard disk drive from the network server via a network. During the test operating system performs diagnosing of the custom-configured computer, the custom-configured computer writes the data corresponding to the shipping image in the network server into the shipping hard disk drive, and writes a master boot record corresponding to the shipping image into the shipping hard disk drive.

The present invention further provides a computer system including a network server, a hard disk drive, a custom-configured computer, and a copy machine. The network server is for storing data corresponding to a shipping image. The hard disk drive has a first portion for storing the data corresponding to the shipping image and a second portion for storing a test operating system. The custom-configured computer is coupled to the network server. The custom-configure computer includes a shipping hard disk drive. The copy machine is coupled to the hard disk drive and the shipping hard disk drive for copying storage data of the hard disk drive after deleting the data corresponding to the shipping image of the hard disk drive into the shipping hard disk drive. During the test operating system performs diagnosing of the custom-configured computer, the custom-configured computer writes the data corresponding to the shipping image in the network server into the shipping hard disk drive, and writes a master boot record corresponding to the shipping image into the shipping hard disk drive.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a computer system according to a preferred embodiment of the present invention.

FIG. 2 is a flowchart of utilizing the computer system in FIG. 1 to simultaneously perform run-in and image downloading steps.

FIG. 3 is a diagram of a network server in FIG. 1 being utilized to write data corresponding to a shipping image into a custom-configured computer.

FIG. 4 is a functional block diagram of a computer system according to another preferred embodiment of the present invention.

FIG. 5 is a flowchart of utilizing the computer system in FIG. 4 to simultaneously perform the run-in and image downloading steps.

### DETAILED DESCRIPTION

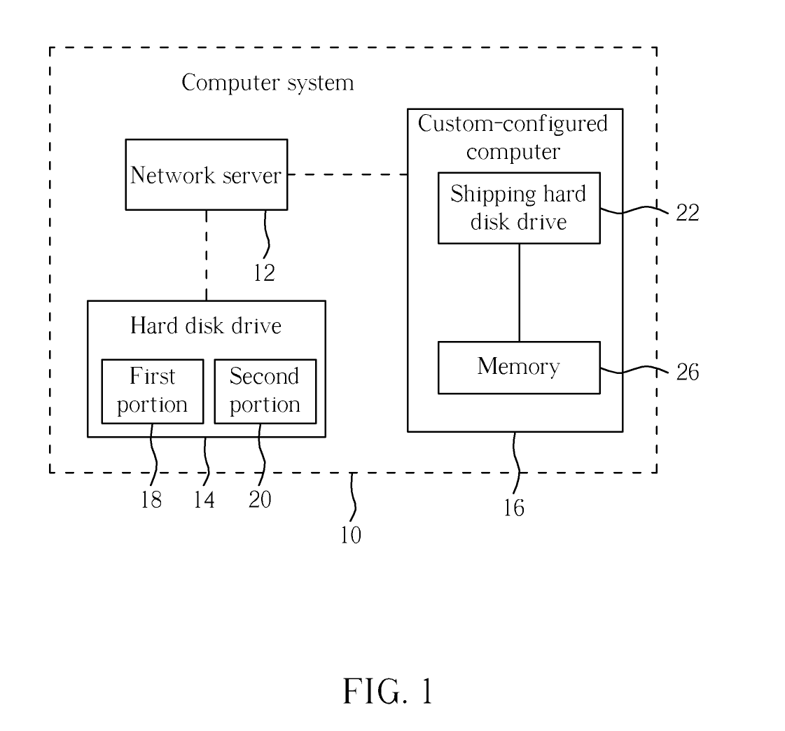

Please refer to FIG. 1, which is a functional block diagram of a computer system 10 according to a preferred embodiment of the present invention. The computer system 10 includes a network server 12, a hard disk drive 14, and a custom-configured computer 16. The network server 12 is used for storing data corresponding to a shipping image and storage data of the hard disk drive 14 after deleting all data corresponding to the shipping image of the hard disk drive 14. The shipping image is a mapping file generated by mapping a shipping system via a system backup/recover tool, including software (e.g. OS (Operating System), office software) that a customer wants to install into the custom-configured computer 16.

The hard disk drive 14 includes a first portion 18 and a second portion 20. The first portion 18 is used for storing the data corresponding to the shipping image. The second portion 20 is used for storing a test operating system (e.g. hardware-performance test software). The custom-configured computer 16 is coupled to the network server 12. The custom-configured computer 16 includes a shipping hard disk drive 22. The shipping hard disk drive 22 is used for receiving the storage data of the hard disk drive 14 after deleting all data corresponding to the shipping image of the hard disk drive 14 from the network server 12 by a network. The shipping hard disk drive 22 can be a conventional hard disk drive or an SSD (Solid State Disk). During the test operating system performs diagnosing of the custom-configured computer 16, the custom-configured computer 16 writes the data corresponding to the shipping image in the network server 12 into the shipping hard disk drive 22 and writes a master boot record corresponding to the shipping image into the shipping hard disk drive 22. The aforesaid operations can be performed by an operating platform provided cooperatively by hardware (e.g. a motherboard and a central processing unit) and an operating system in the custom-configured computer 16.

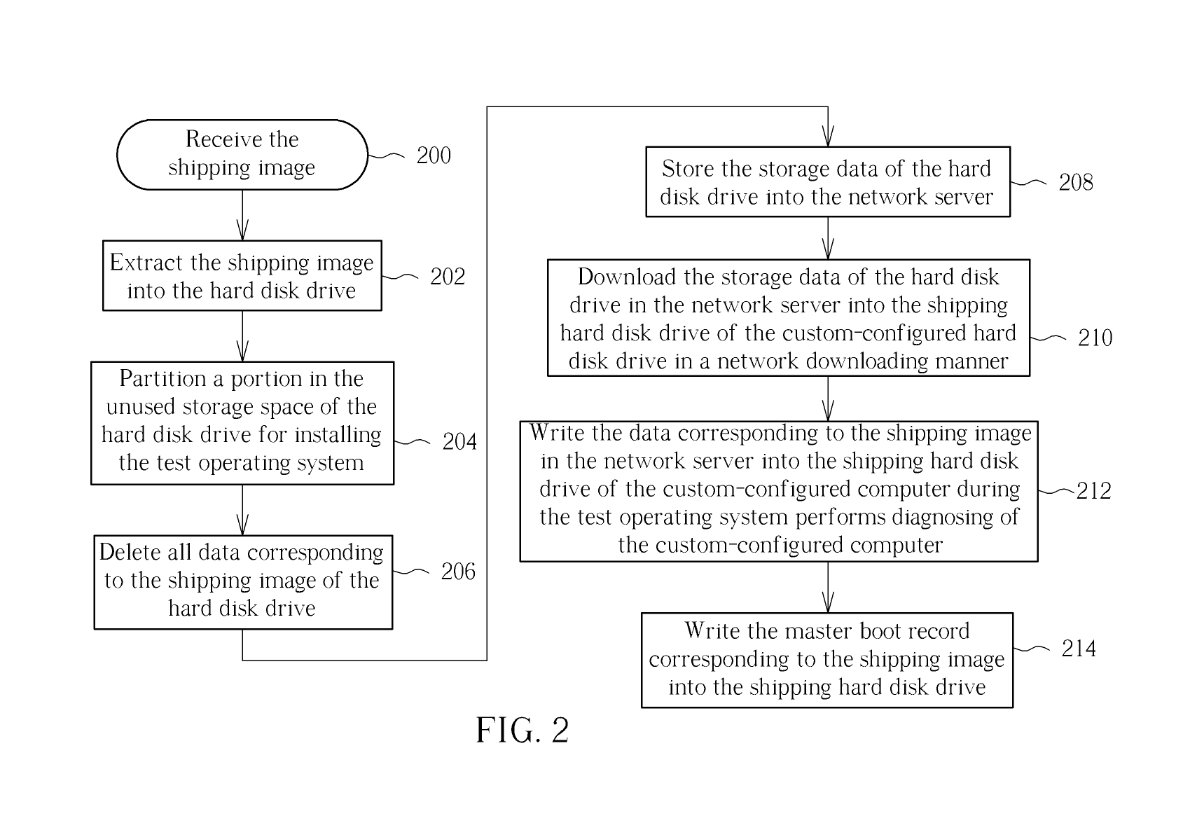

More detailed description for utilizing the computer system 10 in FIG. 1 to simultaneously perform the run-in and image downloading steps according to the present invention is provided as follows. Please refer to FIG. 2, which is a flowchart of utilizing the computer system 10 in FIG. 1 to simultaneously perform the run-in and image downloading steps. Before performing the run-in and image downloading steps on the custom-configured computer 16, the shipping image of the custom-configured computer 16 can be received from the network server 12 (Step 200), and then the shipping image is extracted into the hard disk drive 14 (Step 202). That is to say, in Step 202, the data corresponding to the shipping image is stored into the first portion 18 of the hard disk drive 14.

Subsequently, in Step 204, the second portion 20 is partitioned from the unused storage space of the hard disk drive 14 (i.e. the non-partitioned storage space of the hard disk drive 14 besides the first portion 18) so that the test operating system can be installed in the second portion 20. In such a manner, since the data corresponding to the shipping image and the test operating system are stored in different portions of the hard disk drive 14, the shipping image and the test operating system are independent to each other in data reading/writing of the hard disk drive 14.

After Step 204 is completed, all data corresponding to the shipping image in the first portion 18 of the hard disk drive 14 is deleted (Step 206). That is to say, after Step 206 is performed, only the test operating system is stored in the second portion 20 of the hard disk drive 14. Next, in Step 208, the storage data of the hard disk drive 14 is transformed into files for network downloading and then stored into the network server 12 for subsequent network downloading of the computer system 10.

In such a manner, after hardware assembly of the custom-configured computer 16 is completed and then the custom-configured computer 16 is put on a run-in zone (e.g. a burn-in rack), the storage data of the hard disk drive 14 in the network server 12 can be downloaded into the shipping hard disk drive 22 of the custom-configured computer 16 by a network (Step 210). Accordingly, the storage data and the space configuration of the shipping hard disk drive 22 can be the same as those of the hard disk drive 14, meaning that the shipping hard disk drive 22 also has the second portion 20 where the test operating system is stored and the first portion 18 with no data.

As for network transmission between the network server 12 and the custom-configured computer 16, the related design is commonly seen in the prior art. In other words, all designs for utilizing the network server 12 to download the storage data of the hard disk drive 14 in the network server 12 into the shipping hard disk drive 22 of the custom-configured computer 16 can be adopted by the present invention. For example, the custom-configured computer 16 can further include a memory 26 for receiving an operating system (e.g. a Win-PE operating system or a Linux operating system) in the network server 12 after the custom-configured computer 16 is coupled to the network server 12 in a network booting manner. Accordingly, the shipping hard disk drive 22 can receive the storage data of the hard disk drive 14 in the network server 12 by a network in the said operating system.

In Step 212, the processing unit 24 utilizes the test operating system stored in the second portion 20 of the shipping hard disk drive 22 to test the overall performance of the custom-configured computer 16. During this test, the custom-configured computer 16 writes the data corresponding to the shipping image in the network server 12 into the first portion 18 of the shipping hard disk drive 22 at the same time. At this time, as mentioned above, since the shipping image and the test operating system are independent to each other in data reading/writing of a hard disk drive, the custom-configured computer 16 can write the data corresponding to the shipping image in the network server 12 into the first portion 18 of the shipping hard disk drive 22 without influencing the operating performance of the test operating system. Thus, the purpose of simultaneously performing diagnosing and image downloading of the custom-configured computer 16 can be achieved, so as to greatly save time needed for performing the run-in and image downloading steps of the computer system 10.

Finally, after diagnosing and image downloading of the custom-configured computer 16 is completed, the custom-configured computer 16 writes the master boot record corresponding to the shipping image into the zero track of the shipping hard disk drive 22 (Step 214), so as to make the space configuration of the shipping hard disk drive 22 conform to the shipping request of the custom-configured computer 16. To be noted, after writing the master boot record into the shipping hard disk drive 22, the second portion 20 can be disappeared or hidden, meaning that the second portion 20 where the test operating system is stored can be selectively deleted for preventing a user from getting the related test data or not for the future maintenance of the custom-configured computer 16.

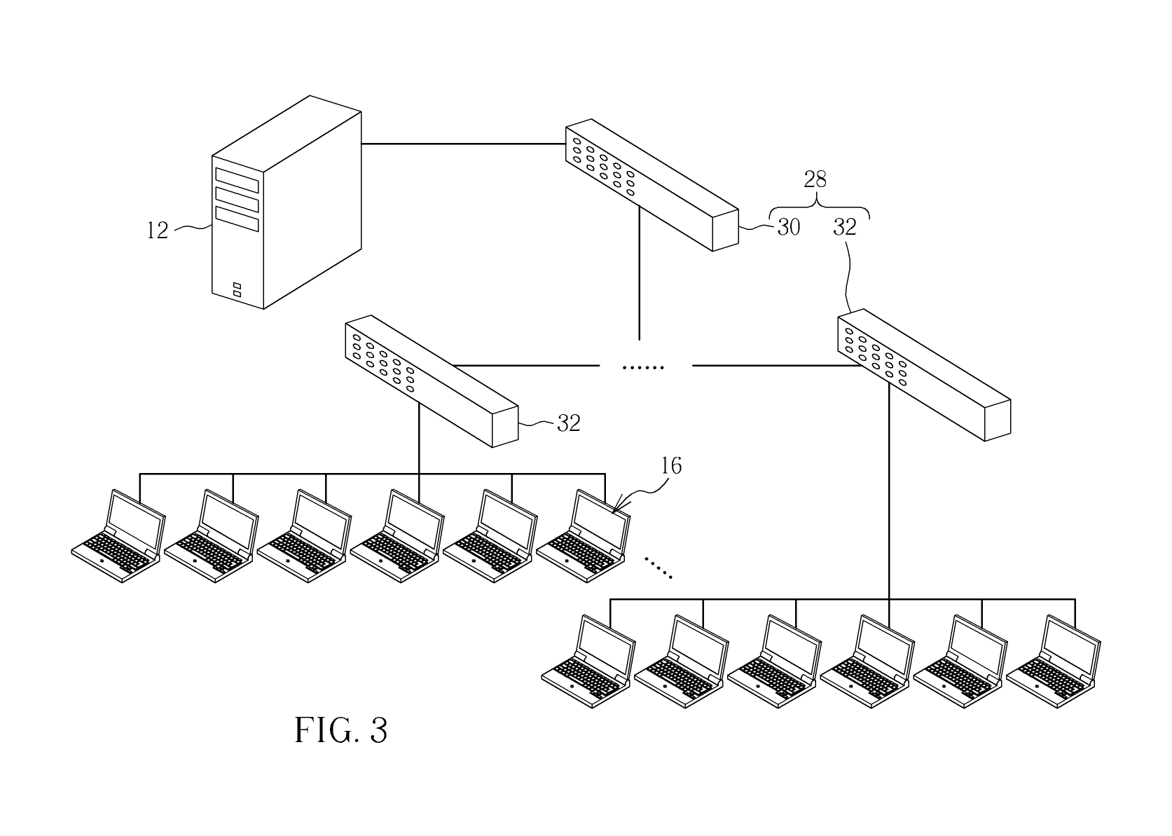

It should be mentioned that utilizing the network server 12 to write the data corresponding to the shipping image into the shipping hard disk drive 22 is not limited to the one-to-one design mentioned in the aforesaid embodiment, meaning that it can also be applied to the many-to-many design for improving the shipping efficiency of the computer system 10. For example, please refer to FIG. 3, which is a diagram of the network server 12 in FIG. 1 being utilized to write the data corresponding to the shipping image into the custom-configured computer 16. As shown in FIG. 3, the computer system 10 can further include a switch device 28. The switch device 28 includes at least one core switch 30 and at least one edge switch (but not limited thereto) for performing network transmission between the network server 12 and the custom-configured computer 16 on condition that the interface of the custom-configured computer 16 is a RJ45/Lan interface or a USB interface. The custom-configured computer 16 can also be directly coupled to the network server 12 without the switch device 28, or only utilize the core switch 30 or edge switch 32 to be coupled to the network server 12. Furthermore, the computer system 10 can also utilize a transfer system instead if the interface of the custom-configured computer 16 is an interface of a special specification. For example, if the interface of the custom-configured computer 16 is a USB 3.0 interface, the computer system 10 can utilize a transfer system for transforming a RJ45 interface to a USB 3.0 interface. In this embodiment, the network server 12 and the core switch 30 expand the bandwidth of the network to 4G via four cables, and the core switch 30 expand the bandwidth of the network to 2G via two cables.

In this embodiment, the computer system 10 preferably utilizes four network servers 12, four core switches 30, and sixty-two edge switches 32 (but not limited thereto). Furthermore, for preventing the image downloading efficiency of the custom-configured computer 16 from being influenced, the related network test may be not performed on the custom-configured computer 16 selectively during the test operating system performs diagnosing of the custom-configured computer 16.

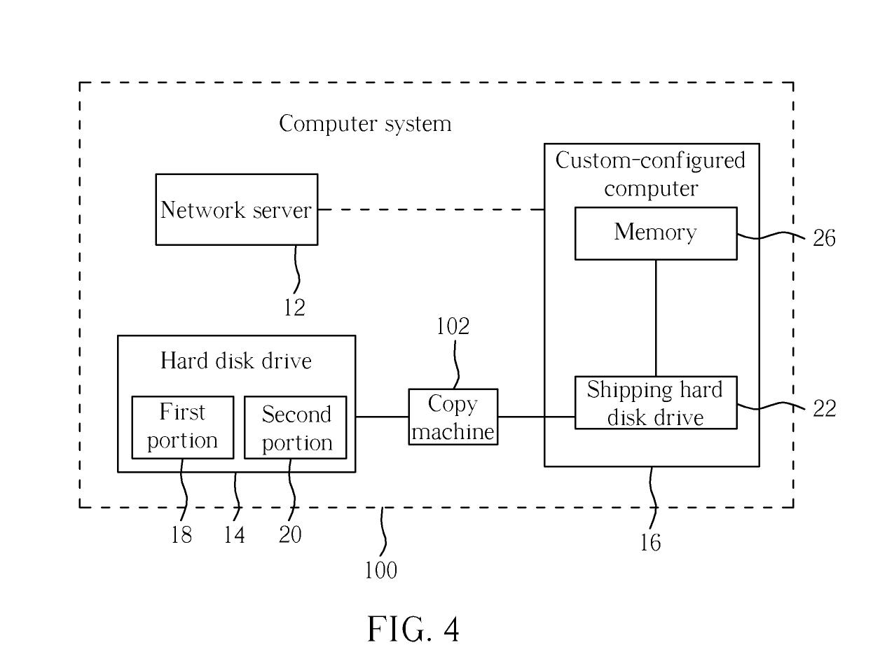

Pleas refer to FIG. 4, which is a functional block diagram of a computer system 100 according to another preferred embodiment of the present invention. Components both mentioned in this embodiment and the aforesaid embodiment represent components with similar functions or structures, and the related description is omitted herein. The computer system 100 includes the network server 12, the hard disk drive 14, the custom-configured computer 16 and a copy machine 102. The copy machine 102 is coupled to the hard disk drive 14 and the shipping hard disk drive 22 for copying the storage data of the hard disk drive 14 after deleting all data corresponding to the shipping image of the hard disk drive 14 to the shipping hard disk drive 22.

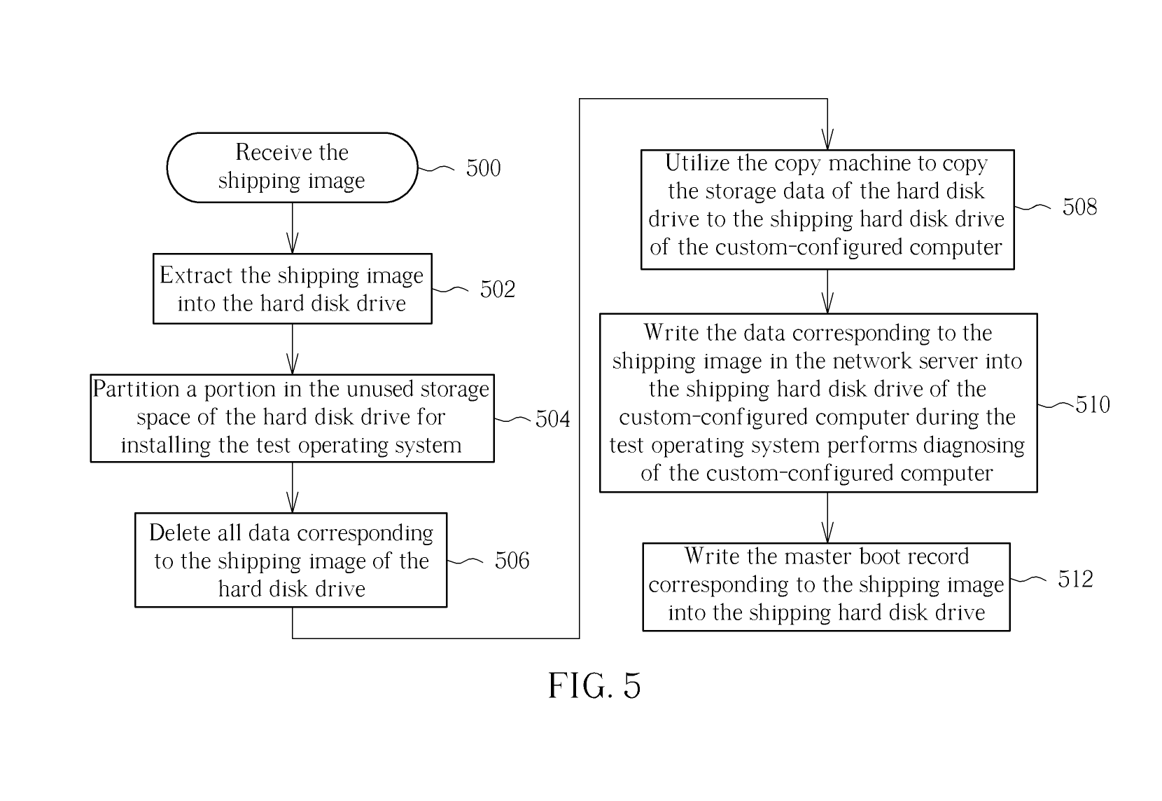

More detailed description for utilizing the computer system 100 in FIG. 4 to simultaneously perform the run-in and image downloading steps according to the present invention is provided as follows. Please refer to FIG. 5, which is a flowchart of utilizing the computer system 100 in FIG. 4 to simultaneously perform the run-in and image downloading steps. The major difference between FIG. 2 and FIG. 5 is the step for writing the storage data of the hard disk drive 14 into the shipping hard disk drive 22 (i.e. Step 508). As for the other steps, they can be reasoned by analogy according to the aforesaid embodiment, and the related description is omitted herein. In Step 508, the storage data of the hard disk drive 14 is directly copy into the shipping hard disk drive 22 by the copy machine 102 instead of the network downloading design mentioned in the aforesaid embodiment. Accordingly, as mentioned above, the custom-configured computer 16 can write the data corresponding to the shipping image in the network server 12 into the first portion 18 of the shipping hard disk drive 22 without influencing the operating performance of the test operating system. Thus, the purpose of simultaneously performing diagnosing and image downloading of the custom-configured computer 16 can be achieved, so as to greatly save time needed for performing the run-in and image downloading steps of the computer system 100.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for simultaneously performing diagnosing and image downloading of a custom-configured computer, the method comprising:
receiving a shipping image;
extracting the shipping image into a hard disk drive;
partitioning a portion in a unused storage space of the hard disk drive;
installing a test operating system into the portion of the hard disk drive;
deleting all data corresponding to the shipping image of the hard disk drive;
writing storage data of the hard disk drive into a shipping hard disk drive of at least one custom-configured computer;
writing data corresponding to the shipping image in a network server into the shipping hard disk drive during the test operating system performs diagnosing of the custom-configured computer; and
writing a master boot record corresponding to the shipping image into the shipping hard disk drive.

2. The method of claim 1, wherein writing the storage data of the hard disk drive into the shipping hard disk drive of the custom-configured computer comprises:
utilizing a copy machine to copy the storage data of the hard disk drive into the shipping hard disk drive of the custom-configured computer.

3. The method of claim 1, wherein writing the storage data of the hard disk drive into the shipping hard disk drive of the custom-configured computer comprises:
storing the storage data of the hard disk drive into the network server; and
downloading the storage data of the hard disk drive in the network server into the shipping hard disk drive of the custom-configured computer via a network.

4. The method of claim 3, wherein downloading the storage data of the hard disk drive in the network server into the shipping hard disk drive of the custom-configured computer via the network comprises:
coupling the custom-configured computer to the network server in a network booting manner;
downloading an operating system in the network server into the custom-configured computer; and
downloading the storage data of the hard disk drive in the network server into the shipping hard disk drive of the custom-configured computer via the network in the operating system.

5. The method of claim 4, wherein downloading the operating system in the network server into the custom-configured computer comprises:
downloading the operating system in the network server into a memory of the custom-configured computer.

6. The method of claim 4, wherein writing the data corresponding to the shipping image in the network server into the shipping hard disk drive during the test operating system performs diagnosing of the custom-configured computer comprises:
coupling the custom-configured computer to the network server via a switch device.

7. The method of claim 1 further comprising:
deleting or hiding data corresponding to the test operating system of the shipping hard disk drive after writing the master boot record corresponding to the shipping image into the shipping hard disk drive.

8. A computer system comprising:
a hard disk drive having a first portion for storing data corresponding to a shipping image and a second portion for storing a test operating system;
a network server coupled to the hard disk drive for storing the data corresponding to the shipping image and storage data of the hard disk drive after deleting all data corresponding to the shipping image of the hard disk drive; and
a custom-configured computer coupled to the network server, the custom-configure computer comprising:
a shipping hard disk drive for receiving the storage data of the hard disk drive after deleting the data corresponding to the shipping image of the hard disk drive from the network server via a network;
wherein during the test operating system performs diagnosing of the custom-configured computer, the custom-configured computer writes the data corresponding to the shipping image in the network server into the shipping hard disk drive, and writes a master boot record corresponding to the shipping image into the shipping hard disk drive.

9. The computer system of claim 8, wherein the custom-configured computer further comprises a memory, the custom-configured computer is used to couple to the network server in a network booting manner for storing an operating system into the memory, and the shipping hard disk drive is used for receiving the storage data of the hard disk drive from the network server by the network in the operating system.

10. The computer system of claim 9, wherein the operating system is a Win-PE operating system or a Linux operating system.

11. The computer system of claim 8, wherein the custom-configured computer is used for deleting or hiding data corresponding to the test operating system of the shipping hard disk drive after writing the master boot record corresponding to the shipping image into the shipping hard disk drive.

12. The computer system of claim 8, wherein the custom-configured computer is coupled to the network server via a switch device.

13. The computer system of claim 12, wherein the switch device comprises at least one of at least one core switch and at least one edge switch for coupling to the network server and the custom-configured computer.

14. The computer system of claim 8 further comprising:
a transfer system coupled to the network server and the custom-configured computer.

15. A computer system comprising:
a network server for storing data corresponding to a shipping image;
a hard disk drive having a first portion for storing the data corresponding to the shipping image and a second portion for storing a test operating system;
a custom-configured computer coupled to the network server, the custom-configure computer comprising a shipping hard disk drive; and
a copy machine coupled to the hard disk drive and the shipping hard disk drive for copying storage data of the hard disk drive after deleting the data corresponding to the shipping image of the hard disk drive into the shipping hard disk drive;
wherein during the test operating system performs diagnosing of the custom-configured computer, the custom-configured computer writes the data corresponding to the shipping image in the network server into the shipping hard disk drive, and writes a master boot record corresponding to the shipping image into the shipping hard disk drive.

16. The computer system of claim 15, wherein the custom-configured computer is used for deleting or hiding data corresponding to the test operating system of the shipping hard disk drive after writing the master boot record corresponding to the shipping image into the shipping hard disk drive.

17. The computer system of claim 15, wherein the computer system further comprises a switch device, and the custom-configured computer is coupled to the network server via the switch device.

18. The computer system of claim 17, wherein the switch device comprises at least one of at least one core switch and at least one edge switch for coupling to the network server and the custom-configured computer.

19. The computer system of claim 15 further comprising:
a transfer system coupled to the network server and the custom-configured computer.

20. The computer system of claim 15, wherein the shipping hard disk drive is a solid state disk.
